(19) United States
(12) Patent Application Publication
(10) Pub. No.: US 2007/0044312 A1
(43) Pub. Date: Mar. 1, 2007

(54) Bearing sleeve fixing mechanism, manufacturing method thereof and fan device having the same

(75) Inventors: Masahiko Hirata, Oita (JP); Yasushi Ayabe, Oita (JP); Makoto Wada, Oita (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/509,562

(22) Filed: Aug. 25, 2006

(30) Foreign Application Priority Data
Aug. 29, 2005 (JP) 2005-247124

(51) Int. Cl. F16B 17/00

(52) U.S. Cl. 29/898.07; 403/345

(57) ABSTRACT

The invention relates to a bearing sleeve fixing mechanism adapted for a fan device to cool a heat generating component like MPU incorporated into a personal computer or a heat sink thermally connected to the heat generating component, a method of manufacturing the bearing sleeve fixing mechanism, and a fan device having the bearing sleeve fixing mechanism. The bearing sleeve fixing mechanism comprises: a shaft; a bearing sleeve, into which one end portion of the shaft is inserted, for pivotally supporting the shaft; a housing for accommodating the bearing sleeve; and a fixing ring press-fitted into the housing so that the bearing sleeve can be interposed between the fixing ring and a receiving mount provided in the housing, wherein the fixing ring fixes the bearing sleeve by giving a plastic deformation to the housing so that a recess portion can be formed in the housing.

### BACKGROUND OF THE INVENTION

1. Field of the Invention

The present invention relates to a bearing sleeve fixing mechanism adapted for a fan device to cool a heat generating component such as a micro-processing unit (referred to as MPU hereinafter) incorporated into a personal computer or used for cooling a heat sink which is thermally connected to the heat generating component by a heat pipe. The present invention also relates to a manufacturing method of manufacturing the bearing sleeve fixing mechanism. The present invention also relates to a fan device having the bearing sleeve fixing mechanism.

2. Related Art

Recently, electronic devices such as computers and others have made rapid progress in the data processing speed, that is, the data processing speed has been quickly increased and the clock frequency of heat generating components such as MPU has been greatly raised as compared with the clock frequency used before. Therefore, the heating value is increased. Accordingly, temperatures of electronic components exceed the operational temperature ranges of the components. As a result, malfunction is caused in the electronic components and further the electronic components are thermally broken down.

Accordingly, in order to normally operate each heat generating component mounted on the electronic device, it is necessary to maintain each heat generating component in an operational temperature range. Therefore, maintaining the heat generating component in the operational temperature range is an important task to operate the electronic device in a stable condition.

Concerning the conventional method of cooling a heat generating electronic component, the following method is widely used. A heat sink including a plurality of heat radiating fins is directly contacted with a heat generating electronic component so that the heat generating electronic component can be naturally cooled. Further, the heat sink is cooled by a fan device when a blast of air is blown by the fan device to the heat sink. Recently, the following method is also used. In a heat sink module in which a heat receiving unit directly connected with the heat generating electronic component is thermally connected with a radiator, which is located at a distant position, by a heat pipe, the radiator is forcibly cooled by a blast of air sent from a fan device.

On the other hand, a high performance computer has been recently spread. This high performance computer needs a cooling device in which a liquid coolant is forcibly circulated by a pump so as to convey heat from a heat receiving unit to a radiator and then the radiator is cooled by a blast of air blown by a fan device.

Concerning the fan device used for cooling various electronic devices, it is necessary to reduce the size and weight. Further, it is necessary to reduce the manufacturing cost.

Concerning the fan device in which the heat sink is integrated into one body so as to enhance the cooling performance, for example, Patent Document 1 (the official gazette of JP-A-11-252859) discloses a fan device and its bearing fixing mechanism in which a dynamic fluid bearing is provided so that the operational noise can be reduced, the life can be prolonged and the reliability can be enhanced.

FIG. 17 is a sectional view showing a bearing fixing mechanism of the fan device. A housing 100a is vertically arranged at a substantial center of a frame 100. A bearing sleeve 101 is engaged with the housing 100a. On an inner circumferential face of the bearing sleeve 101, two dynamic pressure generating grooves 103, which are provided for smoothly rotating a shaft 102, are formed by means of ball rolling. Oil 104 is supplied into these dynamic pressure generating grooves 103 so that the oil 104 can function as lubricant. In this way, a radial bearing 105 is composed while a bearing gap on one side of 2 to 12 μm with the shaft 102 is being maintained.

On the other hand, the fan 106 and the shaft 102 are molded being integrated with each other into one body. The shaft 102 is attached with a washer 107 which is provided for preventing the shaft 102 from coming out.

The shaft 102 is contacted with a thruster 108 and pivotally engaged in the bearing sleeve 101. An end face of the shaft 102 on the opposite side to the fan 106 is finished into a spherical face and contacted with the thruster 108 so that a thrust bearing 109 can be composed.

In this case, a fixing ring 110 is inserted into the housing 100a. This fixing ring 110 fixes the bearing sleeve 101 by interposing the bearing sleeve 101 between the fixing ring 110 and a receiving mount 100b in a sandwich state. Therefore, stress given to the bearing sleeve 101 in the radial direction can be reduced.

That is, since a deformation of the inner diameter of the bearing sleeve 101 can be reduced, the following conventional problems are seldom caused. A gap formed between the shaft 102 and the sleeve 101 becomes uneven and a pumping force of the dynamic pressure generating grooves 103 is lowered. Further a centrifugal whirling of the shaft 102 is caused and furthermore the shaft 102 comes into contact with the bearing sleeve 101 and the oil 104 leaks out. Since the above conventional problems can be prevented, the reliability of the device is seldom deteriorated.

Further, in the periphery of a base portion of the shaft 102, an oil pool 106a, the volume of which is not less than the volume of the gap between the bearing sleeve 101 and the shaft 102, is formed. Further, the fixing ring 110 and a rib 106b, which is formed on an outer circumference of the oil pool 106a, are opposed to each other while a very small gap is being formed between them. Therefore, by utilizing a surface tension generated on the interface, the redundant oil 104, which has been scattered from the bearing sleeve 101 at the time of rotation, can be positively kept in the oil pool 106b so that a leakage of the oil can be prevented.

On the other hand, although not shown in the drawing, another bearing fixing mechanism is provided as follows. For example, as disclosed in Patent Document 2 (the official gazette of JP-A-2004-263710), an outer circumferential face of a bearing sleeve is held being appropriately pushed by an inner face of a housing. In addition to that, while an annular member, which is press-fitted into a housing, is coming into contact with an upper portion of the bearing sleeve, the annular member can be positively fixed surrounding the periphery.

Due to the above mechanism, even when stress given between the bearing sleeve and the housing is reduced, since the annular member is located and fixed at an upper portion of the bearing sleeve, it is possible to prevent the bearing sleeve from being disconnected from the housing.

Further, since the shaft and the annular member are opposed to each other leaving a very small gap between them, the gap forms an interface of the redundant oil which has scattered from the bearing sleeve at the time of rotation. Therefore, a leakage of oil can be prevented.

In the fixing mechanism of the bearing sleeve 101 of Patent Document 1 described before, while the fluctuation caused in the process of machining is being taken into account, the bearing sleeve 101 is inserted into the housing 100a with a very small gap of not more than 0.1 mm. Alternatively, the bearing sleeve 101 is lightly press-fitted into the housing 100a with an interference of not more than 5 μm.

That is, while stress given to the bearing sleeve 101 from the housing 100a in the radial direction is being reduced, the bearing sleeve 101 is fixed being interposed between the receiving mount 100b and the fixing ring 110. Therefore, a deformation of the inner diameter of the bearing sleeve 101 is reduced. Accordingly, the effect described before can be provided.

However, on the hand, the bearing sleeve 101 is fixed in the housing 100a being interposed only by the fixing ring 110. Therefore, in order to prevent the bearing sleeve 101 from coming out, it is necessary for the fixing ring 110 to positively hold the bearing sleeve 101 between the fixing ring 110 and the receiving mount 100b. Further, in order to prevent the rotation of the bearing sleeve 101, it is necessary for the fixing ring 110 to positively push the bearing sleeve 101. Alternatively, it is necessary for the fixing ring 110 to bite into the bearing sleeve 101.

At the initial stage, the fixing ring 110 is positively press-fitted into the housing 110a and fixed by utilizing the press-fitting stress. However, on the other hand, the housing 100a is located at the substantial center of the stator on which a drive circuit board and a plurality of coils, which are not shown in the drawing, are mounted. Therefore, the housing 100a is surrounded by these heat generating electronic components. Accordingly, in the operational state, a temperature of the housing 100a is raised to about 100° C. in some cases. Therefore, it is impossible to neglect an influence of creep caused in the housing 110a when it is used at a high temperature over a long period of time.

That is, when the housing 100a is used over a long period of time at a high temperature under the condition that the housing 100a is continuously given a press-fitting stress generated when the fixing ring 110 is press-fitted, the housing 100a is plastically deformed and the inner diameter of the housing 100a is expanded. Accordingly, there is a possibility that the press-fitting stress is gradually reduced and the fixing ring 110 is displaced and comes out.

Therefore, in order to ensure a high reliability, it is necessary that an amount of the creep is small. In other words, it is necessary for the housing 100a to be made of material, the characteristic of which is described as follows. Even when the housing 100a is used at a high temperature over a long period of time, an elongation of the metallic material caused by the press-fitting stress of the fixing ring 110 is small, and a press-fitting stress generated at the time of manufacturing is not greatly reduced at a high temperature by a change in the characteristic with time. Therefore, the housing 100a is mostly made of alloy used for aluminum die-casting.

In order to obtain a predetermined press-fitting stress at the time of manufacturing, it is necessary to select a metallic material, the mechanical strength of which is appropriately high, and further it is necessary to conduct a precise casting. Further, in order to enhance the mechanical strength, it is necessary to conduct a heat treatment according to the composition of the alloy to be used.

Accordingly, it is necessary to accomplish the following task. An outer diameter of the press-fitting portion of the fixing ring 110 is highly accurately machined, and an inner diameter of the portion of the housing 100a, into which the fixing ring 110 is press-fitted, is also highly accurately machined. That is, the outer diameter of the press-fitting portion of the fixing ring 110 and the inner diameter of the portion of the housing 100a, into which the fixing ring 110 is press-fitted, need to be highly accurately machined so that a predetermined press-fitting stress can be obtained in a dimensional range in which plastic deformation is not conducted but only elastic deformation is conducted.

Further, the following problem may be encountered. In order to ensure a high reliability, it is very important to select a metallic material and reduce the generation of creep by which not only a mechanical strength at a normal temperature but also a mechanical strength at a high temperature can be ensured. Since a range of selecting the usable metallic material is restricted as described above, the manufacturing cost is raised because of the material expenses and the expenses necessary for heat treatment.

The following problem may be encountered. In the fixing mechanism of fixing the bearing sleeve described in Patent Document 2, when the bearing sleeve is press-fitted into the housing and an intensity of the pushing force in the radial direction from the housing to the bearing sleeve is not sufficiently high, the fixing ring comes into contact with the bearing sleeve in such a manner that the fixing ring pushes the bearing sleeve. Therefore, it is necessary for the fixing ring to be positively press-fitted into the housing. Further, in order to ensure a high reliability, an amount of the creep needs to be small and a value of the press-fitting stress generated at the time of manufacturing must not be greatly reduced.

The following problem may be encountered. In the case where the housing is made of resin material, deformation and creep are generated in the same manner when the resin material is softened at a high temperature. Therefore, the usable material is restricted.

### SUMMARY OF THE INVENTION

It is an object of the present invention to provide a bearing sleeve fixing mechanism characterized in that: the bearing sleeve fixing mechanism can be easily manufactured; the bearing sleeve fixing mechanism is compact; and the manufacturing expenses of heat treatment and others can be reduced. It is another object of the present invention to provide a method of manufacturing the bearing sleeve fixing mechanism. It is still another object of the present invention to provide a fan device having the bearing sleeve fixing mechanism.

In order to accomplish the above object, the present invention provides a bearing sleeve fixing mechanism for fixing a bearing sleeve used for a motor. The bearing sleeve fixing mechanism includes: a shaft; a bearing sleeve, into which one end portion of the shaft is inserted, so that the shaft can be pivotally supported by the bearing sleeve; a housing in which the bearing sleeve is accommodated; and a fixing ring press-fitted into the housing so that the bearing sleeve can be interposed between the fixing ring and a receiving mount provided in the housing, wherein the fixing ring is fixed to the bearing sleeve being given a plastic deformation by which a recess portion is formed in the housing.

### BRIEF DESCRIPTION OF THE DRAWINGS

FIG. 1 is a perspective view showing a fan device of Embodiment 1 of the present invention.

FIG. 2 is a perspective view showing a fan device in a state in which a fan cover is removed from the fan device of Embodiment 1 of the present invention.

FIG. 3 is a sectional view of a motor portion taken on line A-A in FIG. 2.

FIG. 4 is a sectional view of a primary portion of the bearing sleeve fixing mechanism of Embodiment 1 of the present invention.

FIG. 5 is an exploded perspective view of the bearing sleeve fixing mechanism of Embodiment 1 of the present invention.

FIG. 6 is an exploded perspective view of the bearing sleeve fixing mechanism of Embodiment 1 of the present invention.

FIG. 7A is a perspective view of the fixing ring of Embodiment 1 of the present invention.

FIG. 7B is a sectional view of the fixing ring of Embodiment 1 of the present invention.

FIGS. 8A to 8C are enlarged views showing stepwise a primary portion of the fixing mechanism of the bearing sleeve of Embodiment 1 of the present invention.

FIG. 9A is a diagram showing a change in the fixing strength before and after a high temperature shelf test of Embodiment 1 of the present invention.

FIG. 9A is a diagram showing a change in the fixing strength before and after a high temperature shelf test of the conventional art

FIG. 10A is a perspective view showing a fixing ring of Embodiment 2 of the present invention.

FIG. 10B is a sectional view showing a fixing ring of Embodiment 2 of the present invention.

FIGS. 11A to 11C are enlarged views showing stepwise a primary portion of the fixing mechanism of the bearing sleeve of Embodiment 2 of the present invention.

FIG. 12A is a perspective view showing a fixing ring of Embodiment 3 of the present invention.

FIG. 12B is a sectional view showing a fixing ring of Embodiment 3 of the present invention.

FIGS. 13A to 13C are enlarged views showing stepwise a primary portion of the fixing mechanism of the bearing sleeve of Embodiment 3 of the present invention.

FIGS. 14A to 14C are enlarged views showing stepwise a primary portion of the fixing mechanism of the bearing sleeve of Embodiment 4 of the present invention.

FIGS. 15A to 15C are enlarged views showing stepwise a primary portion of the fixing mechanism of the bearing sleeve of Embodiment 5 of the present invention.

FIG. 16 is a view showing an inner portion of a casing of an electronic device on which a fan device of the present invention is mounted.

FIGS. 17 a sectional view showing a bearing fixing mechanism of a conventional fan device.

### DETAILED DESCRIPTION OF THE INVENTION

Referring to the accompanying drawings, an embodiment of the present invention will be explained below. In the following explanation, a bottom wall side of the fan casing is defined as “downward” and a fan side of the fan casing is defined as “upward” in the drawings.

### Embodiment 1

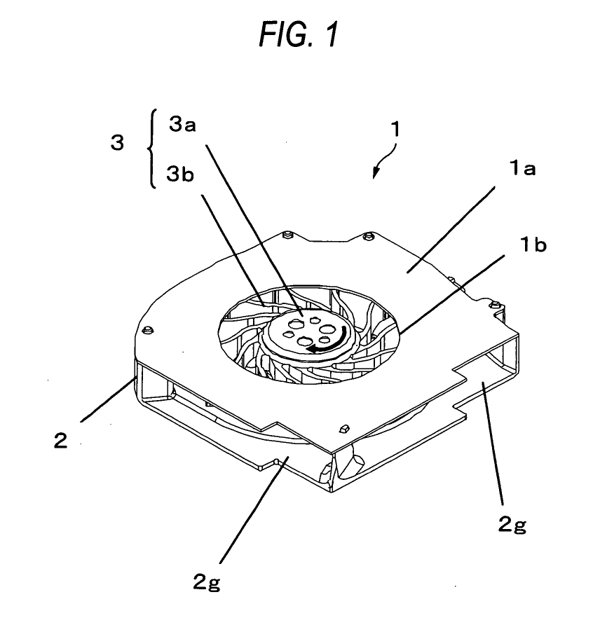

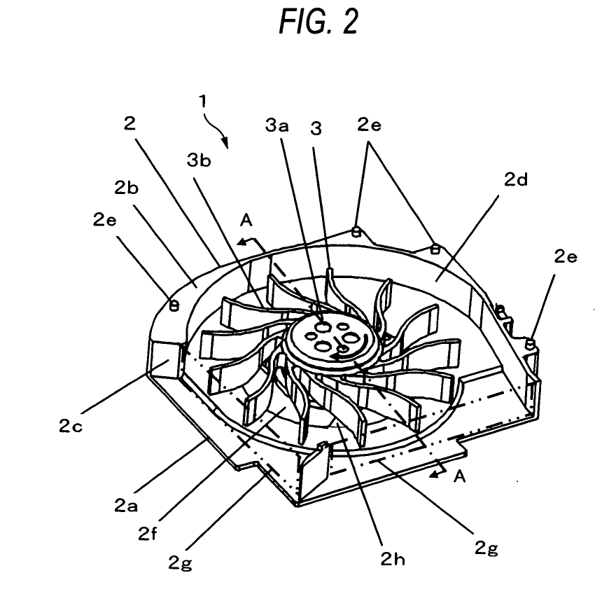

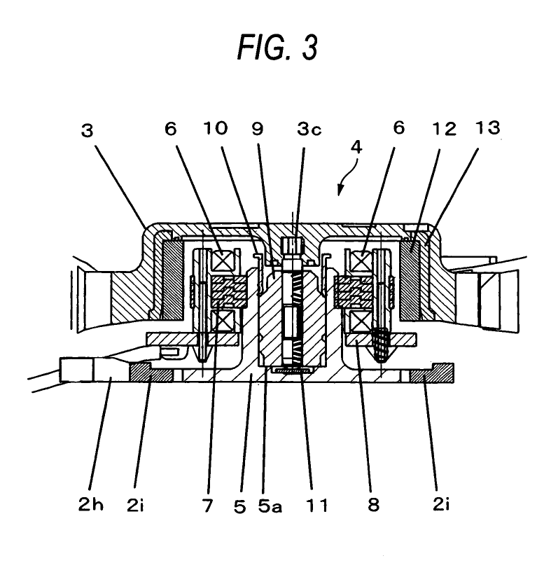

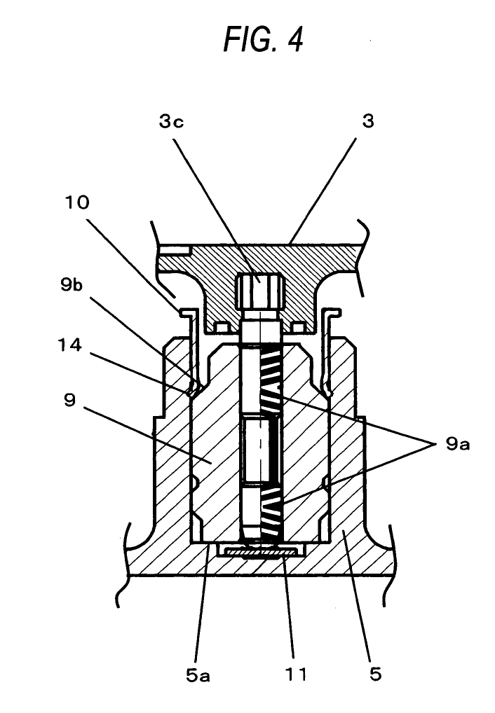

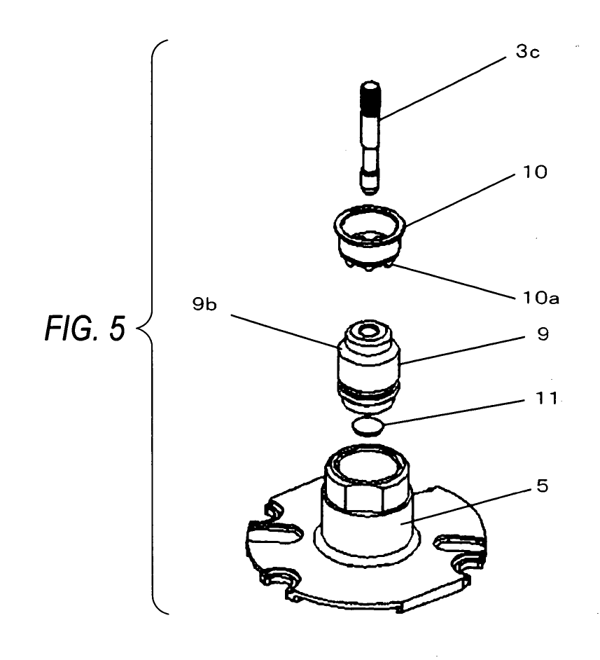

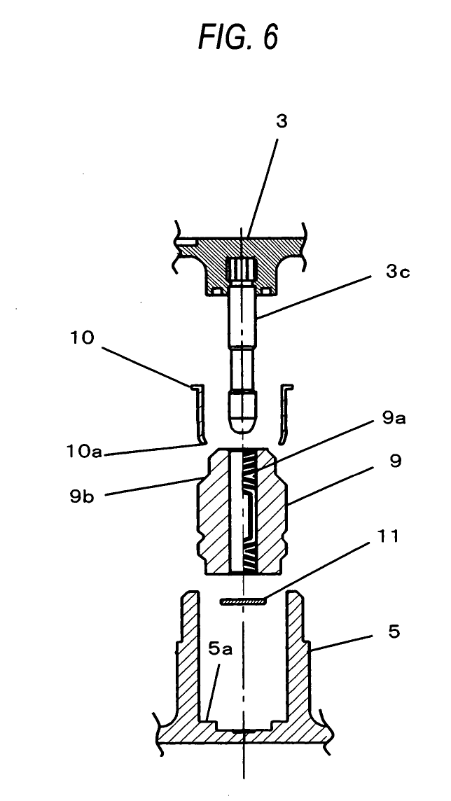

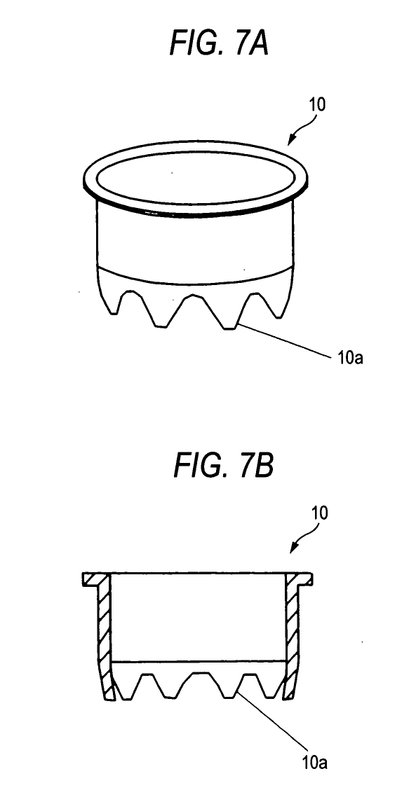

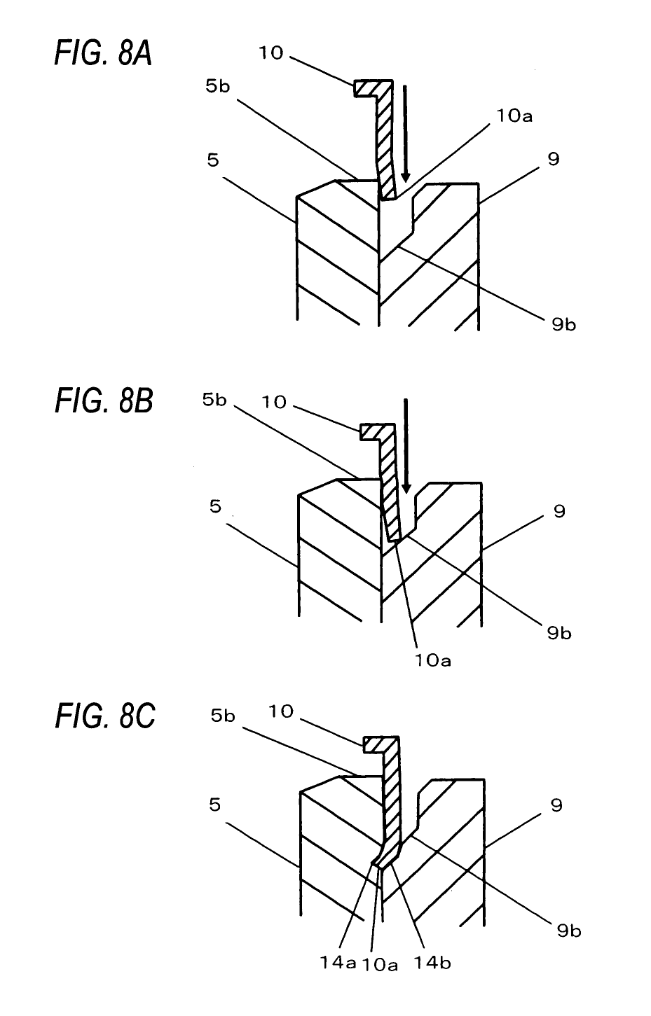

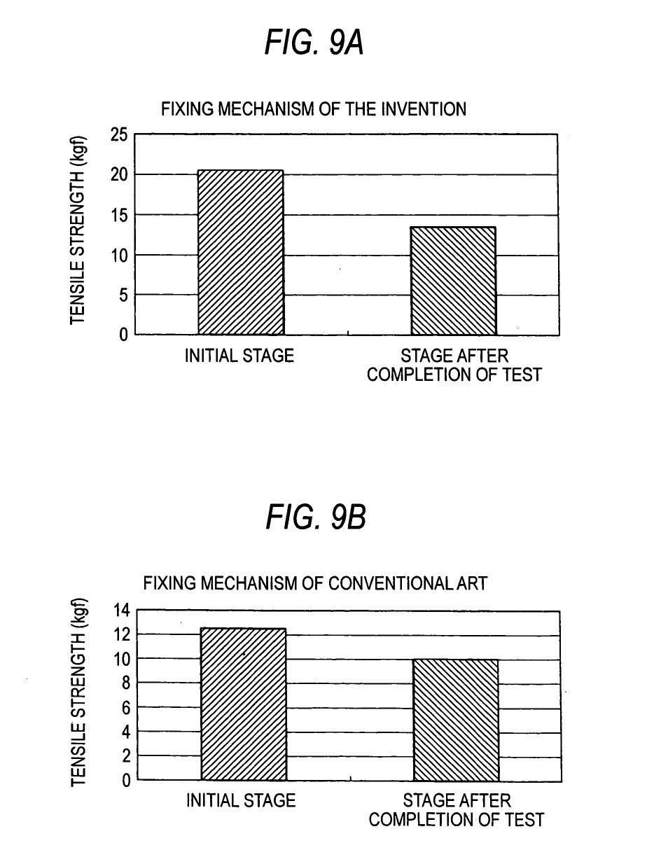

In FIGS. 1 to 9B, FIG. 1 is a perspective view showing a fan device of Embodiment 1 of the present invention, FIG. 2 is a perspective view showing a fan device in a state in which a fan cover is removed from the fan device of Embodiment 1 of the present invention, FIG. 3 is a sectional view of a motor portion taken on line A-A in FIG. 2, FIG. 4 is a sectional view of a primary portion of the bearing sleeve fixing mechanism of Embodiment 1 of the present invention, FIG. 5 is an exploded perspective view of the bearing sleeve fixing mechanism of Embodiment 1 of the present invention, FIG. 6 is an exploded perspective view of the bearing sleeve fixing mechanism of Embodiment 1 of the present invention, FIG. 7A is a perspective view of the fixing ring of Embodiment 1 of the present invention, FIG. 7B is a sectional view of the fixing ring of Embodiment 1 of the present invention, FIGS. 8A to 8C are enlarged views showing stepwise a primary portion of the fixing mechanism of the bearing sleeve of Embodiment 1 of the present invention, FIG. 9A is a diagram showing a change in the fixing strength before and after a high temperature shelf test of Embodiment 1 of the present invention, and FIG. 9B is a diagram showing a change in the fixing strength before and after a high temperature shelf test of the conventional art

First of all, as shown in FIG. 1, the centrifugal fan device 1 includes: a fan casing 2 located in a lower portion; a fan cover 1a located in an upper portion of the fan casing 2; and a fan 3 accommodated being interposed between the fan casing 2 and the fan cover 1a.

The fan casing 2 is formed by means of resin molding or die-casting of aluminum alloy so that a bottom face and a side face are integrated with each other into one body. On two sides of the fan casing 2, two exhaust ports 2g for discharging the sucked air are provided. On the bottom face of the fan casing 2, a lower suction port 2f (shown in FIG. 2) is provided.

The fan cover 1a is formed into a plate shape out of metallic material such as aluminum or stainless steel by means of punching or the fan cover 1a is formed out of resin by means of molding. At the central portion of the fan cover 1a, a substantially circular upper suction port 1b for sucking air is arranged.

Further, the fun 3 is arranged being interposed between the fan cover 1a and the fan casing 2. The fan 3 includes: a boss portion 3a having a cylindrical outer circumferential face; and a plurality of blade portions 3b radially extending from the outer circumferential face in the centrifugal direction.

In this case, when the fan 3 is rotated at high speed in the direction shown by an arrow, air is sucked in the direction of the shaft 3c (shown in FIG. 3) of the fan 3 described later from an upper suction port 1b, which is arranged in the central portion of the fan cover 1a in such a manner that the upper suction port 1b is opposed to an upper face of the boss portion 3a, and from a lower suction port 2f provided on the bottom face of the fan casing 2. Further, the thus sucked air is blown in the centrifugal direction of a plurality of blade portions 3b by the rotary motion of the blade portions 3b inside the centrifugal fan device 1. Accordingly, while most of the sucked air is colliding with inner walls of the fan casing 2 and the fan cover 1a, the air is sent in the same direction as that of the rotary direction of the fan 3 along the inner walls of the fan casing 2 and the fan cover 1a. Accordingly, the air is discharged from the exhaust port 2g.

As shown in FIG. 2, the fan casing 2 of the fan device 1 includes: a bottom wall 2a; and a side wall 2b. Inside of the side wall 2b, an inner circumferential face, which is formed into a substantial circle, is formed except for the exhaust face 2c, and the fan casing 2 is formed into a flat box shape. In an upper portion of the fan casing 2, a flat-plate-shaped fan cover 1a (shown in FIG. 1) is fixed to the fan casing 2 when the fan cover 1a is engaged with a plurality of protrusions 2e for joining which are formed on an upper edge end face of the fan casing 2 and then the protrusions 2e for joining are caulked. The fan casing 2 is usually made of resin material such as PPS, PBT or PET or metallic material having a high forming property such as aluminum alloy used for die-casting.

In this case, at the central portion on the bottom wall 2a of the fan casing 2, a substantially circular lower suction port 2f is formed. As shown by the two-dotted chain line in the drawing, in a predetermined portion of the side wall 2b of the fan casing 2, a substantially rectangular exhaust port 2g, which is interposed between the fan cover 1a and the fan casing 2, is formed. Therefore, the sucked air is exhausted in the two directions. At a substantially central portion of the lower suction port 2f, an annular holding portion 2i (shown in FIG. 3), which is supported by three supporting members 2h, is arranged. In an upper portion of the annular holding portion 2i, the fan 3 is mounted.

The fan 3 includes: a cylindrical boss portion 3a; and a plurality of blade portions 3b which are extended substantially radially from an outer circumferential face of the boss portion 3a. A motor portion 4 (shown in FIG. 3) for driving the fan 3 is arranged in such a manner that the motor portion 4 is covered with the boss portion 3a.

Next, as shown in FIG. 3, the motor portion 4 is composed on the inner circumferential side of the annular holding portion 2i provided continuously to the support member 2h. The motor portion 4 has a disk-shaped bottom face. A housing 5, the substantially central portion of which is cylindrically protruded, is fixed on the inner circumferential side of the annular holding portion 2i. A stator 7, round which a coil 6 is wound, and a drive circuit board 8, on which Hall element not shown is mounted, are arranged in the periphery of the housing 5. In this way, a stationary body of the motor portion 4 is composed.

On the other hand, inside the housing 5, a bearing sleeve 9 is accommodated, into which a lower end portion of the shaft 3c incorporated into the fan 3 by means of integral molding is inserted so that the shaft 3c can be pivotally supported. A fixing ring 10 is press-fitted onto the opening side of the housing 5 so that the bearing sleeve 9 can be interposed between the fixing ring 10 and the receiving mount 5a formed in the housing 5.

The shaft 3c is engaged in the bearing sleeve 9 under the condition that the shaft 3c comes into contact with a thrust sheet 11.

In the fan 3, a magnet 12 and a magnet yoke 13 are arranged being opposed to the annular stator 7. In this way, a rotary body of the motor portion 4 is composed.

In the motor portion 4 composed as described above, when electric power is supplied to the drive circuit board 8, an electric current flows in each coil 6 wound round the stator 7, and a magnetic force is generated in the stator 7. In the magnet 12, N-pole and S-pole are alternately magnetized in the circumferential direction. Therefore, these magnetic poles and the magnetic force generated in the stator 7 attract each other and the fan 3 is rotated. At this time, Hall element (not shown) mounted on the drive circuit board 8 detects N-pole and S-pole of the magnet and generates an output signal. When an electric current flowing in each coil is controlled by the output signal of Hall element so that it can be commutated, a magnetic pole of the magnetic force generated in the stator 7 is successively changed and attracted by N-pole and S-pole of the magnet 12. Therefore, the fan 3 is continuously rotated in a predetermined rotary direction shown by the arrow in FIG. 1. When the fan 3 is rotated, the outside air is sucked from the lower suction port 2f and the upper suction port 1b formed on the fan cover 1a (shown in FIG. 1). The thus sucked air is discharged from the exhaust port 2g described before.

More specific explanations will be made referring to FIG. 4 as follows. The shaft 3c, which is incorporated into the fan 2 by means of integral molding, is made of stainless steel such as SUS 420J2 because the abrasion resistance and the handling property of stainless steel are excellent. The bearing sleeve 9, into which a lower end portion of the shaft 3c is inserted so that the shaft 3c can be pivotally supported, is made of copper alloy such as C3604 or BC6C because the cutting property and the rolling property of the copper alloy are excellent.

The bearing sleeve 9 is a fluid bearing having dynamic pressure generating grooves 9a inside. Concerning the oil used as fluid, since the fan device 1 is arranged close to a heat generating electronic component so as to cool it in many cases, fluorine synthetic fluid, the heat resistance of which is high, is used for the oil.

In this case, in order to prevent the bearing sleeve 9 from coming out and rotating, the bearing sleeve 9 is fixed only by the fixing ring 10 being interposed. However, first, in the connecting portion 14, a plastic deformation is given so that the fixing ring 10 can bite into the housing 5 so as to form a recess portion. In this way, the bearing sleeve 9 is fixed. Therefore, this method is advantageous in that the fixing ring 10 can directly connect the housing 5 with the bearing sleeve 9. Accordingly, the housing 5 and the bearing sleeve 9 can be strongly joined to each other.

At the same time, in the joining portion 14, a plastic deformation is given so that the fixing ring 10 can also bite into the bearing sleeve 9 and form a recess portion. Therefore, even when a value of the press-fitting stress of the fixing ring 10 into the housing 5 is low, the bearing sleeve 9 can be more strongly fixed to the housing 5. Accordingly, a value of the press-fitting stress of the fixing ring 10 into the housing 5 may be lower than that of a conventional case.

That is, a plastic deformation is given and the fixing ring 10 fixes the bearing sleeve 9 in such a manner that the fixing ring 10 bites into both the housing 5 and the bearing sleeve 9.

Accordingly, it becomes unnecessary to highly accurately machine the outer diameter of the press-fitting portion of the fixing ring 10 and the inner diameter of the portion of the housing 5 into which the fixing ring 10 is press-fitted. Accordingly, manufacturing can be easily executed. Further, it is possible to use metallic material such as zinc, zinc alloy, copper alloy or iron which is difficult to be used for the conventional bearing sleeve fixing mechanism because an amount of creep is large. Furthermore, it is possible to use resin material, which is relatively inexpensive, such as PBT, PPS or PC. Therefore, usable material can be selected from a wide range. Accordingly, the material expenses and the expenses necessary for heat treatment can be reduced.

Depending upon the composition of an alloy used for the housing 5, there is a possibility that the heat treatment, which is conventionally needed for enhancing the mechanical strength when the generation of creep is taken into account, can be simplified.

Further, a mechanical strength required for the portion of the housing 5, into which the fixing ring 10 is press-fitted, may be low. Therefore, the wall thickness of this portion can be reduced. Accordingly, the size and weight can be reduced and the manufacturing cost can be also reduced.

On the other hand, a gap formed between the bearing sleeve 9 and the housing 5, into which the fixing ring 10 is press-fitted, is formed out of the straight inner face of the housing 5 and the outer circumferential face 9b of the bearing sleeve 9, the diameter of which is gradually expanded in the press-fitting direction (in the direction from the top to the bottom). Since this gap is formed so that the diameter can be gradually decreased in the press-fitting direction of the fixing ring 10, when the fixing ring 10 is press-fitted, the fixing ring 10 is pushed outside by the contact with the outer circumferential face of the bearing sleeve 9. Accordingly, a forward end portion 10a (shown in FIGS. 5, and 6) of the fixing ring 10 in the press-fitting direction easily bites into the housing 5. Therefore, according to this mechanism, a plastic deformation can be easily given in such a manner that the fixing ring 10 forms a recess portion in the housing 5.

In the direction opposite to the direction in which the fixing ring 10 is press-fitted so that the recess portion can be formed in the bearing sleeve 9, that is, in the direction from the bottom to the top, which is the direction in which the fixing ring 10 comes out, the fixing ring 10 is engaged. Therefore, the fixing ring 10 is more strongly connected to the housing 5, and the connection is seldom loosened even when vibration or shock is given to the device even when the device is dropped.

Next, referring to FIGS. 5 and 6, a method of assembling the bearing sleeve fixing mechanism will be explained below.

First of all, in the first step in which the bearing sleeve 9 is accommodated in the housing 5, the thrust sheet 11 is inserted into a bottom portion of the housing 5 which is made of zinc alloy by means of molding. Next, the bearing sleeve 9 is inserted into the housing 5 while leaving a gap of not more than 0.1 mm. Alternatively, the bearing sleeve 9 is press-fitted by an interference of not more than 5 μm. A lower end face of the bearing sleeve 9 comes into contact with the receiving mount 5a (shown in FIG. 6) arranged in the housing 5. In this way, the bearing sleeve 9 is accommodated in the housing 5.

When assembling is conducted in this way, a value of stress in the radial direction given to the bearing sleeve 9 from the housing 5 can be reduced. Accordingly, the inner diameter of the bearing sleeve 9 can be prevented from being deformed.

As a result, a gap formed between the shaft 3c and the bearing sleeve 9 can be maintained to be uniform. Accordingly, a pumping force generated by the dynamic pressure generating grooves 9a (shown in FIG. 6) can be stabilized and the whirling of the shaft 3c can be reduced. Further, it is possible to prevent the occurrence of problems in which the shaft 3c is contacted with the bearing sleeve 9 and the oil leaks out. That is, the reliability can be enhanced.

Next, in the second step in which the fixing ring 10 is press-fitted into the housing 5, the fixing ring 10 is press-fitted into the housing 5 until the fixing ring 10 comes into contact with the outer circumferential face 9b of the bearing sleeve 9.

In the third step in which a plastic deformation is given to the housing 5 so that a recess portion can be formed in the housing 5 by the fixing ring 10, the fixing ring 10 is pushed in the press-fitting direction and pushed and deformed outside by the outer circumferential face 9b of the bearing sleeve 9. While the fixing ring 10 is being pushed in the press-fitting direction in this way, the end portion 10a of the fixing ring 10 makes a plastic deformation in such a manner that the end portion 10a of the fixing ring 10 bites into the housing 5 and forms a recess portion. In this way, the fixing ring 10 is strongly connected to the housing 5. At the same time, a plastic deformation is made in such a manner that the fixing ring 10 bites into the bearing sleeve 9 so as to form a recess portion. In this way, the fixing ring 10 is strongly connected to the bearing sleeve 9. Accordingly, it is possible to effectively prevent the occurrence of problems in which the bearing sleeve 9 is rotated together with the shaft 3c, the vibration is increased and the bearing sleeve 9 is seized.

That is, the present invention adopts a method of manufacturing a bearing sleeve fixing mechanism including: the first step in which the bearing sleeve 9 is accommodated in the housing 5; the second step in which the fixing ring 10 is press-fitted or inserted into the housing 5; and the third step in which the bearing sleeve 9 is fixed by giving a plastic deformation in which the fixing ring 10 forms a recess portion in the housing 5. Accordingly, a press-fitting portion of the fixing ring 10 into the housing 5 or an inserting portion of the fixing ring 10 into the housing 5 can be easily machined. Further, it is possible to select metallic material or relatively inexpensive resin material which is difficult to be used for a conventional bearing sleeve fixing mechanism because an amount of the generated creep is large. Therefore, according to the manufacturing method of the present invention, it is possible to reduce material expenses and working expenses such as an expense of heat treatment.

After the bearing sleeve 9 has been fixed by the fixing ring 10, the oil described before is supplied into the dynamic pressure generating grooves 9a formed on the inner surface of the bearing sleeve 9. Then, a lower end portion of the shaft 3c, which is integrally incorporated into the fan 3 by means of integral molding, is inserted into the bearing sleeve 9. Therefore, the bearing sleeve 9 can pivotally support the fan 3. Assembling is executed in the manner described above.

As shown in FIG. 7A, the end portion 10a of the fixing ring 10, by which a plastic deformation is given to the housing 5 and the bearing sleeve 9 so that a recess portion can be formed, is formed into a protruding and recessing shape. Therefore, when the fixing ring 10 pushes the housing 5 and the bearing sleeve 9, a protruding portion of the end portion 10a of the fixing ring 10 can easily bite into the housing 5 and the bearing sleeve 9, that is, a plastic deformation of forming the recess portion can be easily given. Therefore, the fixing ring 10 is more strongly connected to the housing 5 and the bearing sleeve 9, and the connection is seldom loosened even when vibration or shock is given to the device when the device is dropped.

Further, as shown in FIG. 7B, in order for the fixing ring 10 to easily proceed into the housing 5 at the time of press-fitting, before the fixing ring 10 is press-fitted into the housing 5, the end portion 10a of the fixing ring 10 in the press-fitting direction is slightly inclined inside.

When consideration is given to the elasticity and the working property of the fixing ring 10, further when consideration is given to the plastic deformation for forming the recess portion in the housing 5 or the bearing sleeve 9 into which the end portion 10a of the fixing ring 10 bites, the fixing ring 10 is made of stainless steel such as SUS304, SUS430 or SUS410, the yield point of which is higher than that of the material of the housing 5 or the bearing sleeve 9. That is, the stress at which the plastic deformation is started in the fixing ring 10 is set to be higher than the stress at which the plastic deformation is started in the material of the housing 5 or the bearing sleeve 9.

FIGS. 8A to 8C are enlarged views showing stepwise a primary portion of the fixing mechanism of the bearing sleeve 9 of Embodiment 1 of the present invention. In this structure, an outer diameter of the press-fitting portion of the fixing ring 10 is a little larger than an inner diameter of the portion of the housing 5, into which the fixing ring 10 is press-fitted. FIGS. 8A to 8C show a progress from the press-fitting to the fixing of the fixing ring 10.

First, FIG. 8A is an enlarged view of a primary portion showing a stage of the start of press-fitting of the fixing ring 10. Since the maximum outer diameter of the press-fitting portion of the fixing ring 10 is a little larger than the inner diameter of the portion of the housing 5, into which the fixing ring 10 is press-fitted, when the end portion 10a of the fixing ring 10 on the press-fitting side is press-fitted in the arrowed direction while the end portion 10a of the fixing ring 10 is coming into contact with the opening side end portion 5b of the housing 5, the fixing ring 10 is pushed by the opening side end portion 5b of the housing 5 and press-fitted being elastically deformed inside.

FIG. 8B is an enlarged view of a primary portion showing a stage in the middle of press-fitting the fixing ring 10. Since the end portion 10a of the fixing ring 10 in the press-fitting direction is a little inclined inside before press-fitting the fixing ring 10 so that the end portion 10a of the fixing ring 10 can easily proceed into the housing 5 at the time of press-fitting, the end portion 10a of the fixing ring 10 can smoothly proceed along the inner circumferential face while receiving a press-fitting stress from the housing 5, and the end portion 10a of the fixing ring 10 comes into contact with the outer circumferential face 9b of the bearing sleeve 9. FIG. 8B shows this state.

When the fixing ring 10 is further pushed in the press-fitting direction in this stage, since the end portion 10a of the fixing ring 10 is contacted with the outer circumferential face 9b of the bearing sleeve 9 and pushed outside, a pushing deformation is started in such a manner that the outer diameter of the end portion 10b is increased to a value larger than the outer diameter of the press-fitting portion before the start of press-fitting.

FIG. 8C is an enlarged view of a primary portion showing a stage in which the fixing by the fixing ring 10 has been completed. The end portion 10a of the fixing ring 10, by which a plastic deformation is made so as to form a recess portion in the housing 5, bites into the housing 5 in the first joining portion 14a. Therefore, the fixing ring 10 and the housing 5 are strongly joined to each other. At the same time, in the second joining portion 14b, a plastic deformation is made so that the fixing ring 10 can bite into the bearing sleeve 9 so as to form a recess portion. In this way, the fixing ring 10 is strongly joined to the housing 5. Therefore, even when a value of the press-fitting stress of the fixing ring 10 into the housing 5 is low, the bearing sleeve 9 can be more strongly fixed to the housing 10. Accordingly, the press-fitting stress of the fixing ring 10 into the housing 5 may be lower than that of a conventional case.

At this stage, the end portion 10a of the fixing ring 10, by which a plastic deformation is made so that a recess portion can be made in the housing 5, is pushed and deformed so that it can be expanded in the outer circumferential direction. Therefore, in the direction opposite to the direction in which the fixing ring 10 is press-fitted, that is, in the direction from the bottom to the top, the fixing ring 10 is engaged. Therefore, the fixing ring 10 can be more strongly joined to the housing 5 and not loosened even when the vibration or the shock is given to the device.

In this connection, in order to effectively prevent the bearing sleeve 9 from rotating together with the shaft 3c and in order to effectively prevent an increase in the vibration and a seize of the bearing sleeve 9, it is preferable that the end portion 10a of the fixing ring 10, by which a plastic deformation is made so that a recess portion can be formed in the housing 5, simultaneously conducts a plastic deformation in which the end portion 10a of the fixing ring 10 bites into the bearing sleeve 9 and forms a recess portion. However, in the case where it is sufficient that the fixing ring 10 is pushed and fixed to the bearing sleeve 9, the plastic deformation, in which a recess portion is formed in the bearing sleeve 9, may not given.

It is preferable that the end portion 10a of the fixing ring 10, by which a plastic deformation of forming a recess portion in the housing 5 is given, is made to easily bite into the housing 5 and a shape of the end portion 10a of the fixing ring 10 is formed into a protruding and recessing shape so that a plastic deformation can be easily made. However, in the case where the yield point of the metallic material of the fixing ring 10, which is the stress of starting a plastic deformation, is sufficiently higher than the yield point of the metallic material of the housing 5 and a plastic deformation of forming a recess portion can be easily made, not a protruding and recessing shape but a cut-out or a slit may be locally formed. Alternatively, a simple flat shape or other shape may be made.

In Embodiment 1 of the present invention, in order for the fixing ring 10 to easily proceed into the housing 5 at the time of press-fitting, it is preferable that the end portion 10a in the press fitting direction is slightly inclined inside before press-fitting the fixing ring 10. However, when a sufficiently high elasticity is provided and no problems are caused in the press-fitting work, it is possible to adopt a straight shape or a shape protruding onto the outer circumferential side.

FIG. 9A is a diagram showing a change in the fixing strength before and after a high temperature shelf test of Embodiment 1 of the present invention. FIG. 9A shows an initial fixing strength and a fixing strength after the fixing mechanism was left at a high temperature of 100° C. for 24 hours. FIG. 9B is a diagram showing a change in the fixing strength before and after a high temperature shelf test of the conventional art. FIG. 9B shows an initial fixing strength and a fixing strength after the fixing mechanism was left at a high temperature of 100° C. for 24 hours.

In this case, the fixing strength was determined as follows. The housing 5 and the bearing sleeve 9 were pulled in the opposite direction to each other. A pulling load at which the bearing sleeve 9 came out from the housing 5 was measured. The thus measured pulling loads were averaged and determined to be the tensile strength.

As can be seen in the diagram, in the case where the housing 5 formed out of zinc die-casting alloy by means of molding was used, in the conventional bearing sleeve fixing mechanism, the tensile strength before the high temperature shelf test was 12.5 kgf, and the tensile strength after the high temperature shelf test was 10.0 kgf, that is, the tensile strength after the high temperature shelf test was low. On the other hand, in the bearing sleeve fixing mechanism of Embodiment 1 of the present invention, the tensile strength before the high temperature shelf test was 20.5 kgf, that is, the tensile strength before the high temperature shelf test was higher by about 65%. The tensile strength after the high temperature shelf test was 13.5 kgf, that is, the tensile strength after the high temperature shelf test was higher by about 35%. It can be said that the tensile strength was greatly improved.

In other words, according to Embodiment 1 of the present invention, even zinc die-casting alloy, which was difficult to be used for the conventional bearing sleeve fixing mechanism because an amount of creep is large, can provide a sufficiently high fixing strength.

### Embodiment 2

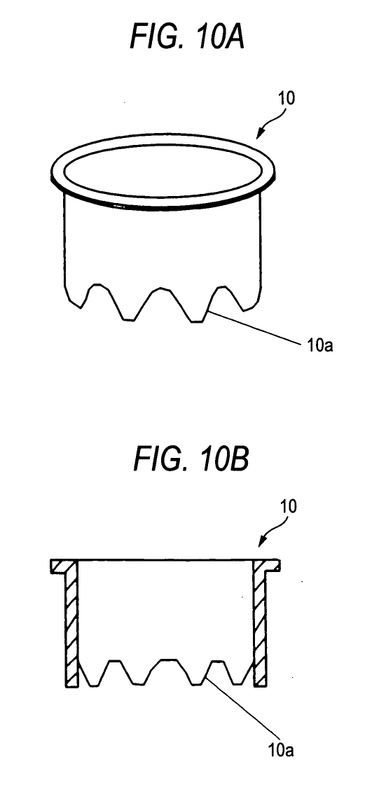

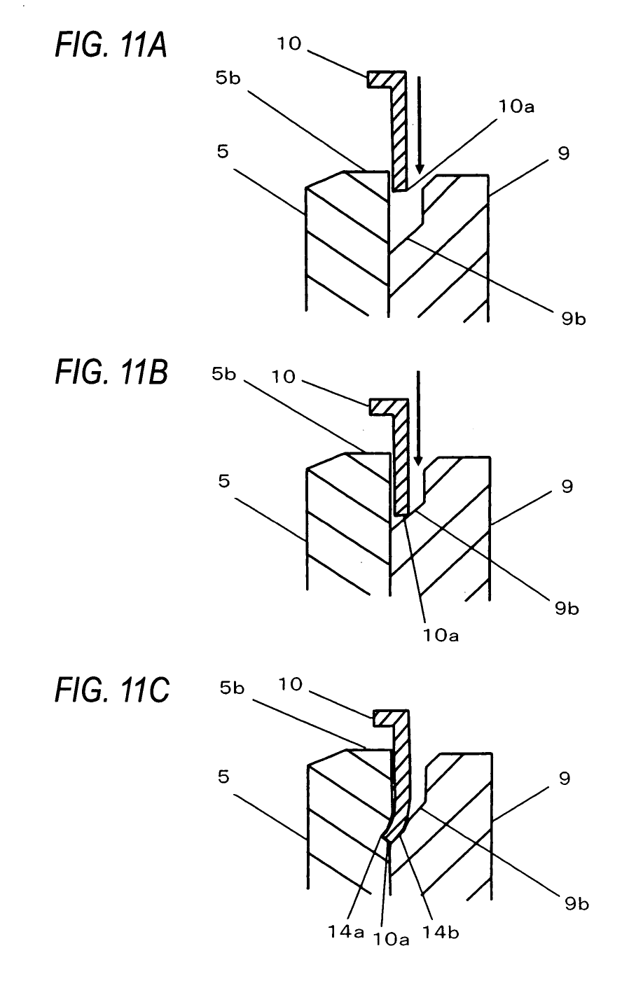

FIG. 10A is a perspective view showing a fixing ring of Embodiment 2 of the present invention. FIG. 10B is a sectional view showing a fixing ring of Embodiment 2 of the present invention. FIGS. 11A to 11C are enlarged views showing stepwise a primary portion of the fixing mechanism of the bearing sleeve of Embodiment 2 of the present invention.

First, as shown in FIG. 10A, the end portion 10a of the fixing ring 10, by which a plastic deformation is given to the housing 5 and the bearing sleeve 9 so that a recess portion can be formed, is formed into a protruding and recessing portion. Therefore, when the fixing ring 10 pushes the housing 5 and the bearing sleeve 9, the end portion 10a of the fixing ring 10 can easily bite into the housing 5 and the bearing sleeve 9, that is, a plastic deformation of forming the recess portion can be easily given. Therefore, the fixing ring 10 is more strongly connected to the housing 5 and the bearing sleeve 9, and the connection is seldom loosened even when the vibration or shock is given to the device even when the device is dropped.

Further, as shown in FIG. 10B, an outer diameter of the inserting portion of the fixing ring 10 is set to be a little smaller than an inner diameter of the portion of the housing 5, into which the fixing ring 10 is inserted. Therefore, at the time of insertion, the fixing ring 10 can be easily inserted into the housing 5. Accordingly, the end portion 10a of the fixing ring 10 in the inserting direction is formed into a straight shape.

When consideration is given to the elasticity and the working property of the fixing ring 10, further when consideration is given to the plastic deformation for forming the recess portion in the housing 5 or the bearing sleeve 9 into which the end portion 10a of the fixing ring 10 bites, the fixing ring 10 is made of stainless steel such as SUS304, SUS430 or SUS410, the yield point of which is higher than that of the material of the housing 5 or the bearing sleeve 9. That is, the stress at which the plastic deformation is started in the fixing ring 10 is set to be higher than the stress at which the plastic deformation is started in the material of the housing 5 or the bearing sleeve 9.

FIGS. 11A to 11C are enlarged views showing stepwise a primary portion of the fixing mechanism of the bearing sleeve of Embodiment 2 of the present invention. An outer diameter of the inserting portion of the fixing ring 10 is a little smaller than an inner diameter of the portion of the housing 5, into which the fixing ring 10 is inserted. These views show a progress from the insertion to the fixation of the fixing ring 10.

First, FIG. 11A is an enlarged view of a primary portion showing a stage of starting the insertion of the fixing ring 10. Since the maximum outer diameter of the inserting portion of the fixing ring 10 is set to be a little smaller than the inner diameter of the portion of the housing 5 into which the fixing ring 10 is inserted, the end portion 10a of the fixing ring 10 on the insertion side is inserted in the arrowed direction along the inside of the opening side end portion 5b of the housing 5, and the insertion is started without giving an elastic deformation to the fixing ring 10.

FIG. 11B is an enlarged view of a primary portion showing a stage of the middle of the insertion of the fixing ring 10. The end portion 10a of the fixing ring 10 on the insertion side is formed into a straight shape. An outer diameter of the inserting portion of the fixing ring 10 is a little smaller than an inner diameter of the portion of the housing 5 into which the inserting portion of the fixing ring 10 is inserted. Therefore, while the fixing ring 10 is not being given any stress from the housing 5, the fixing ring 10 smoothly proceeds along the inner circumferential surface of the housing 5, and the end portion 10a of the fixing ring 10 comes into contact with the outer circumferential face 9b of the bearing sleeve 9. FIG. 11B shows this state.

When the fixing ring 10 is further pushed in the inserting direction in this stage, since the end portion 10a of the fixing ring 10 is contacted with the outer circumferential face 9b of the bearing sleeve 9 and pushed outside, a pushing deformation is started in such a manner that the outer diameter of the end portion 10b is increased to a value larger than the outer diameter of the inserting portion before the start of inserting.

In this case, a gap formed between the bearing sleeve 9 and the housing 5, into which the fixing ring 10 is inserted, is composed of the straight-shaped inner face of the housing 5 and the outer circumferential face 9b of the bearing sleeve 9, the diameter of which is gradually expanded in the inserting direction (in the direction from the top to the bottom). This gap is gradually decreased in the inserting direction of the fixing ring 10. Accordingly, when the fixing ring 10 is inserted, it is pushed outside by the contact with the outer circumferential face 9b of the bearing sleeve 9. Accordingly, the forward end portion 10b of the fixing ring 10 in the inserting direction more easily bites into the housing 5. Accordingly, it is easy for the fixing ring 10 to give a plastic deformation so that a recess portion can be formed in the housing 5. Further, it becomes easy to manufacture the device.

FIG. 11C is an enlarged view of a primary portion showing a stage in which the fixing ring 10 completes fixing. The end portion 10a of the fixing ring 10, by which a plastic deformation is made so as to form a recess portion in the housing 5, bites into the housing 5 in the first joining portion 14a. Therefore, the fixing ring 10 and the housing 5 are strongly joined to each other. At the same time, in the second joining portion 14b, a plastic deformation is made so that the fixing ring 10 can bite into the bearing sleeve 9 so as to form a recess portion. In this way, the fixing ring 10 is strongly joined to the housing 5. Therefore, even when the fixing ring 10 is not press-fitted into the housing 5, the bearing sleeve 9 can be more strongly fixed to the housing 10.

That is, the fixing ring 10 makes a plastic deformation in which a recess portion is formed on both the housing 5 and the bearing sleeve 9.

At this stage, the end portion 10a of the fixing ring 10, by which a plastic deformation is made so that a recess portion can be formed in the housing 5, is pushed and deformed so that the end portion 10a can be expanded in the outer circumferential direction. Therefore, in the direction opposite to the direction in which the fixing ring 10 is inserted, that is, in the direction from the bottom to the top, the fixing ring 10 is engaged. Therefore, the fixing ring 10 is more strongly joined to the housing 5, and the device is not loosened even when the vibration or shock is given when it is dropped.

In this connection, in order to effectively prevent the bearing sleeve 9 from rotating together with the shaft 3c and in order to effectively prevent an increase in the vibration and the seize of the bearing sleeve 9, it is preferable that the end portion 10a of the fixing ring 10, by which a plastic deformation is made so that a recess portion can be formed in the housing 5, simultaneously conducts a plastic deformation in which the end portion 10a of the fixing ring 10 bites into the bearing sleeve 9 and forms a recess portion. However, in the case where it is sufficient that the fixing ring 10 is pushed and fixed to the bearing sleeve 9, the plastic deformation, in which a recess portion is formed in the bearing sleeve 9, may not given.

It is preferable that the end portion 10a of the fixing ring 10, by which a plastic deformation of forming a recess portion in the housing 5 is given, is made to easily bite into the housing 5 and a shape of the end portion 10a of the fixing ring 10 is formed into a protruding and recessing shape so that a plastic deformation can be easily made. However, in the case where the yield point of the metallic material of the fixing ring 10, which is the stress of starting a plastic deformation, is sufficiently higher than the yield point of the metallic material of the housing 5 and a plastic deformation of forming a recess portion can be easily made, not a protruding and recessing shape but a simple flat shape or other shape may be made.

Further, in Embodiment 2 of the present invention, the end portion 10a of the fixing ring 10 in the inserting direction is formed into a straight shape. However, as long as a sufficiently high elasticity can be provided and no problems are caused in the process of insertion, the end portion 10a of the fixing ring 10 may be formed in such a manner that it is inclined inside or on the contrary it is protruded onto the outer circumferential side before the fixing ring 10 is inserted.

### Embodiment 3

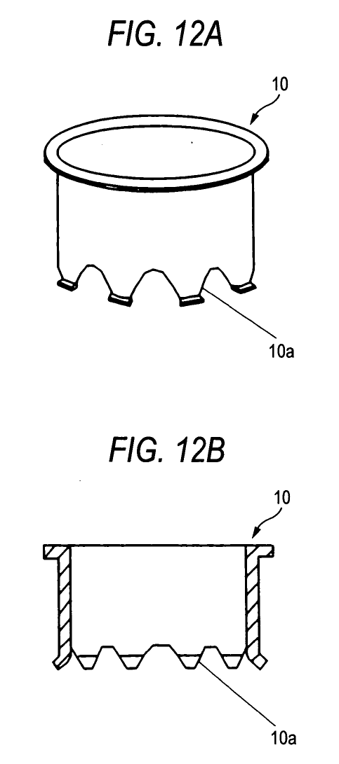

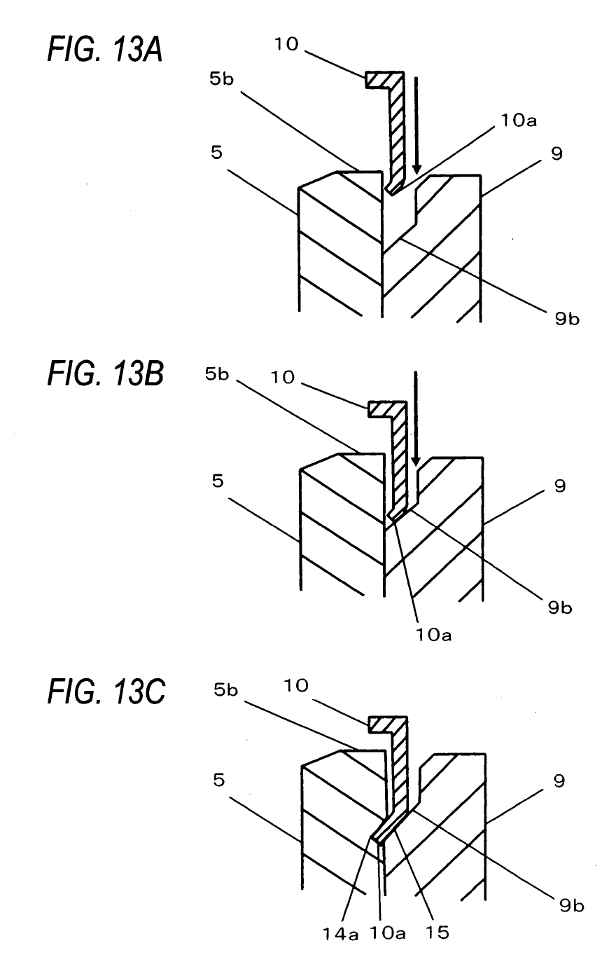

FIG. 12A is a perspective view showing a fixing ring of Embodiment 3 of the present invention. FIG. 12B is a sectional view showing a fixing ring of Embodiment 3 of the present invention. FIGS. 13A to 13C are enlarged views showing stepwise a primary portion of the fixing mechanism of the bearing sleeve of Embodiment 3 of the present invention.

First, as shown in FIG. 12A, the end portion 10a of the fixing ring 10, by which a plastic deformation is given to the housing 5 and the bearing sleeve 9 so that a recess portion can be formed, is formed into a protruding and recessing shape. Therefore, when the fixing ring 10 pushes the housing 5 and the bearing sleeve 9, a protruding portion of the end portion 10a of the fixing ring 10 can easily bite into the housing 5, that is, a plastic deformation of forming the recess portion can be easily given. Therefore, the fixing ring 10 is more strongly connected to the housing 5 and the bearing sleeve 9, and the connection is seldom loosened even when the vibration or shock is given to the device when the device is dropped.

Further, as shown in FIG. 12B, an outer diameter of the inserting portion of the fixing ring 10 is set to be a little smaller than an inner diameter of the portion of the housing 5, into which the fixing ring 10 is inserted. Therefore, at the time of insertion, the fixing ring 10 can be easily inserted into the housing 5. However, the end portion 10a of the fixing ring 10, by which a plastic deformation is made so that a recess portion can be made in the housing 5, is formed being protruded onto the outer circumferential side. Therefore, in the direction opposite to the direction in which the fixing ring 10 is inserted, that is, in the direction from the bottom to the top, the fixing ring 10 is strongly engaged. Therefore, the fixing ring 10 is more strongly joined to the housing 5, and the device is not loosened even when the vibration or shock is given when it is dropped.

When consideration is given to the elasticity and the working property of the fixing ring 10, further when consideration is given to the plastic deformation for forming the recess portion in the housing 5 into which the end portion 10a of the fixing ring 10 bites, the fixing ring 10 is made of stainless steel such as SUS 304, SUS 430 or SUS 410, the yield point of which is higher than that of the material of the housing 5 or the bearing sleeve 9. That is, the stress at which the plastic deformation is started in the fixing ring 10 is set to be higher than the stress at which the plastic deformation is started in the material of the housing 5 or the bearing sleeve 9.

FIGS. 13A to 13C are enlarged views showing stepwise a primary portion of the fixing mechanism of the bearing sleeve of Embodiment 3 of the present invention. An outer diameter of the inserting portion of the fixing ring 10 is a little smaller than an inner diameter of the portion of the housing 5, into which the fixing ring 10 is inserted. These views show a progress from the insertion to the fixation of the fixing ring 10.

First, FIG. 13A is an enlarged view of a primary portion showing a stage of starting the insertion of the fixing ring 10. Since the maximum outer diameter of the inserting portion of the fixing ring 10 is set to be a little smaller than the inner diameter of the portion of the housing 5 into which the fixing ring 10 is inserted, the end portion 10a of the fixing ring 10 on the insertion side is inserted in the arrowed direction along the inside of the opening side end portion 5b of the housing 5, and the insertion is started without giving an elastic deformation to the fixing ring 10.

FIG. 13B is an enlarged view of a primary portion showing a stage of the middle of the insertion of the fixing ring 10. The end portion 10a of the fixing ring 10 on the insertion side is formed into a straight shape. An outer diameter of the inserting portion of the fixing ring 10 is a little smaller than an inner diameter of the portion of the housing 5 into which the inserting portion of the fixing ring 10 is press-fitted. Therefore, while the fixing ring 10 is not being given any stress from the housing 5, the fixing ring 10 smoothly proceeds along the inner circumferential surface of the housing 5, and the end portion 10a of the fixing ring 10 comes into contact with the outer circumferential face 9b of the bearing sleeve 9. FIG. 13B shows this state.

When the fixing ring 10 is further pushed in the inserting direction in this stage, since the end portion 10a of the fixing ring 10 is contacted with the outer circumferential face 9b of the bearing sleeve 9 and pushed outside, a pushing deformation is started in such a manner that the outer diameter of the end portion 10b is increased to a value larger than the outer diameter of the inserting portion before the start of inserting.

In this case, a gap formed between the bearing sleeve 9 and the housing 5, into which the fixing ring 10 is inserted, is composed of the straight-shaped inner face of the housing 5 and the outer circumferential face 9b of the bearing sleeve 9, the diameter of which is gradually expanded in the inserting direction (in the direction from the top to the bottom). This gap is gradually decreased in the inserting direction of the fixing ring 10. Accordingly, when the fixing ring 10 is inserted, it is pushed outside by the contact with the outer circumferential face 9b of the bearing sleeve 9. Accordingly, the forward end portion 10b of the fixing ring 10 in the inserting direction more easily bites into the housing 5. Accordingly, it is easy for the fixing ring 10 to give a plastic deformation so that a recess portion can be formed in the housing 5. Further, it becomes easy to manufacture the device.

FIG. 13C is an enlarged view of a primary portion showing a stage in which the fixing ring 10 completes fixing. The end portion 10a of the fixing ring 10, by which a plastic deformation is made so as to form a recess portion in the housing 5, bites into the housing 5 in the joining portion 14. Therefore, the fixing ring 10 and the housing 5 are strongly joined to each other. Therefore, even when the fixing ring 10 is not press-fitted into the housing 5, the bearing sleeve 9 can be more strongly fixed to the housing 5.

At this stage, the end portion 10a of the fixing ring 10, by which a plastic deformation is made so that a recess portion can be formed in the housing 5, is pushed and deformed so that the end portion 10a can be expanded in the outer circumferential direction. Therefore, in the direction opposite to the direction in which the fixing ring 10 is inserted, that is, in the direction from the bottom to the top, the fixing ring 10 is engaged. Therefore, the fixing ring 10 is more strongly joined to the housing 5, and the device is not loosened even when the vibration or shock is given when it is dropped.

In this connection, in this case, the fixing ring 10 does not make a plastic deformation for forming a recess portion in the bearing sleeve 9. However, the joining portion 14 is located at a position above the contact portion 15 with the bearing sleeve 9 and a sufficiently strong pushing force is given to the bearing sleeve 9. Therefore, it is possible to prevent the bearing sleeve 9 from rotating together with the shaft 3c. Further, an increase in the vibration and the seize of the bearing sleeve 9 can be effectively prevented.

It is preferable that the end portion 10a of the fixing ring 10, by which a plastic deformation is given so as to form a recess portion in the housing 5, is formed into a protruding and recessing shape so that the end portion 10a can easily bite into the housing 5 so as to form the recess portion by the plastic deformation. However, when the yield point of the metallic material used for the fixing ring 10, which is the stress at which a plastic deformation is started, is sufficiently higher than that of the metallic material used for the housing 5 and when a plastic deformation for forming a recess portion can be easily made, the shape of the end portion 10a is not limited to the protruding and recessing shape but the shape of the end portion 10a may be a flat shape and other shapes.

Further, in Embodiment 3 of the present invention, it is preferable that the end portion 10a of the fixing ring 10 in the inserting direction is formed being protruded onto the outer circumferential side. However, as long as a sufficiently high elasticity can be provided and no problems are caused in the process of insertion, the end portion 10a of the fixing ring 10 may be formed in such a manner that it is inclined inside or it is formed into a straight shape before the fixing ring 10 is inserted.

As explained above, when the fixing ring 10 is either press-fitted or inserted into the housing 5, the bearing sleeve can be easily fixed. Therefore, compared with the conventional bearing sleeve fixing mechanism in which the press-fitting stress of the conventional fixing ring 10 is used, it is possible to use metallic material which is difficult to be used for the conventional bearing sleeve fixing mechanism because an amount of creep is large. Furthermore, it is possible to use resin material, which is relatively inexpensive, for the material of the housing 5. Therefore, usable material can be selected from a wide range. Accordingly, the material expenses and the expenses necessary for heat treatment can be reduced.

### Embodiment 4

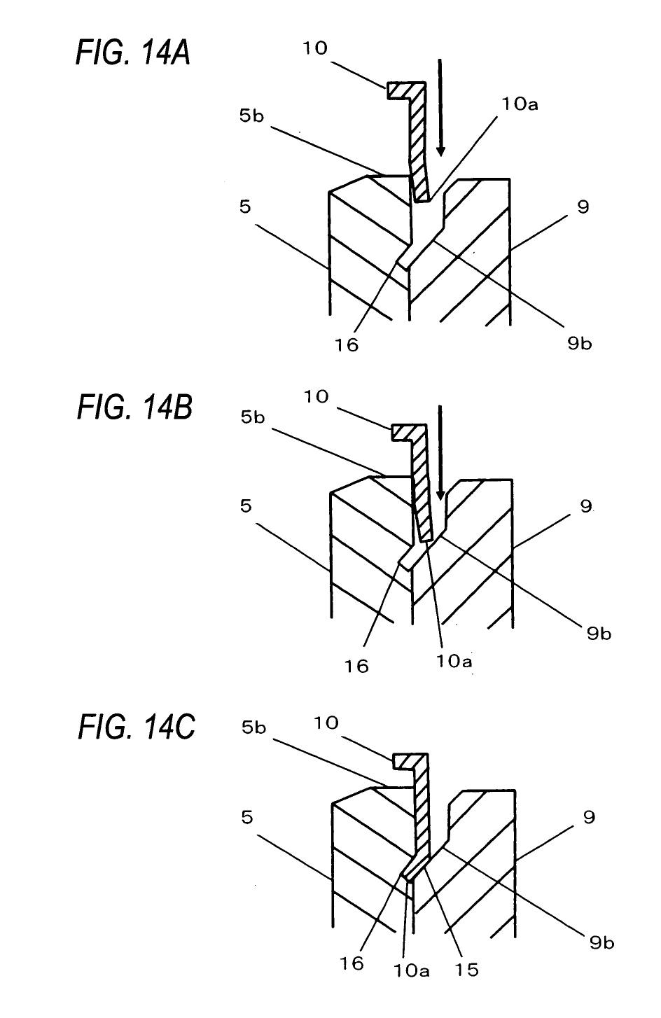

FIGS. 14A to 14C are enlarged views showing stepwise a primary portion of the fixing mechanism of the bearing sleeve of Embodiment 4 of the present invention. In this embodiment, an outer diameter of the press-fitting portion of the fixing ring 10 is set a little larger than the inner diameter of the portion of the housing 5 into which the fixing ring 10 is press-fitted. These views show a progress from the press-fitting to the fixing.

The same fixing ring 10 as that shown in FIGS. 7A and 7B is used.

First, FIG. 14A is an enlarged view of a primary portion showing a stage of starting press-fitting the fixing ring 10 into the housing 5. On an inner face of the housing 5, the recess portion 16 is previously formed. Since the maximum outer diameter portion of the press-fitting portion of the fixing ring 10 is set to be a little larger than the inner diameter of the portion of the housing 5 into which the fixing ring 10 is press-fitted, when the end portion 10a of the fixing ring 10 on the press-fitting side is press-fitted in the arrowed direction while the end portion 10a of the fixing ring 10 is coming into pressure-contact with the opening side end portion 5b of the housing 5, the fixing ring 10 is pushed by the opening side end portion 5b of the housing 5, and the press-fitting of the fixing ring 10 is started while the fixing ring 10 is being elastically deformed inside.

FIG. 14B is an enlarged view of a primary portion showing a middle stage of press-fitting the fixing ring 10 into the housing 5. In order for the fixing ring 10 to easily proceed into the housing 5, the end portion 10a of the fixing ring 10 in the press-fitting direction is a little inclined inside. Therefore, while the end portion 10a of the fixing ring 10 is being given a press-fitting stress from the housing 5, the end portion 10a smoothly proceeds along the inner circumferential face of the housing 5 and comes into contact with the outer circumferential face 9b of the bearing sleeve 9.

When the fixing ring 10 is further pushed in the press-fitting direction at this stage, the end portion 10a of the fixing ring 10 is pushed outside by the contact with the outer circumferential face 9b of the bearing sleeve 9. Therefore, a deformation by pushing is started in such a manner that an outer diameter of the press-fitting portion of the end portion 10a of the fixing ring 10 is expanded to be larger than the outer diameter of the press-fitting portion before press-fitting.

FIG. 14C is an enlarged view of a primary portion showing a stage in which the fixing ring 10 completes fixing. In this structure, the fixing ring 10 is engaged with the recess portion 16, which is previously formed on the inner face of the housing 5, so as to fix the bearing sleeve 9. Therefore, the fixing ring 10 is engaged with the recess portion 16, which is formed on the inner face of the housing 5, and directly joined to the recess portion 16. At the same time, the fixing ring 10 can fix the bearing sleeve 9.

That is, the fixing ring 10 is strongly joined to the housing 5 under the condition that the fixing ring 10 is engaged in the direction opposite to the direction of being press-fitted into the housing 5. Therefore, even when a press-fitting stress of the fixing ring 10 into the housing 5 is low, the bearing sleeve 9 can be more strongly fixed by the fixing ring 10. Accordingly, the press-fitting stress of the fixing ring 10 into the housing 5 may be lower than that of the conventional case.

At this stage, the end portion 10a of the fixing ring 10 to be press-fitted into the housing 5 is pushed and deformed so that the end portion 10a can be expanded in the outer circumferential direction. Therefore, the fixing ring 10 is engaged in the direction opposite to the direction of press-fitting the fixing ring 10, that is, in the direction from the bottom to the top. Accordingly, the fixing ring 10 can be more strongly joined to the housing 5. Therefore, the fixing ring 10 can not be loosened even when the device is vibrated or shocked at the time of a fall.

On the other hand, in the present embodiment, explanations of the step, in which the bearing sleeve 9 is accommodated in the housing 5, is omitted because the step is the same as that of Embodiment 1. However, the present invention adopts a method of manufacturing a bearing sleeve fixing mechanism including: the first step in which the bearing sleeve 9 is accommodated in the housing 5; the second step in which the fixing ring 10 is press-fitted or inserted into the housing 5; and the third step in which the bearing sleeve 9 is fixed when the fixing ring 10 is engaged with the recess portion 16 formed in the inner face of the housing 5. Accordingly, a press-fitting portion of the fixing ring 10 into the housing 5 or an inserting portion of the fixing ring 10 into the housing 5 can be easily machined. Further, it is possible to select metallic material or relatively inexpensive resin material which is difficult to be used for a conventional bearing sleeve fixing mechanism because an amount of the generated creep is large. Therefore, according to the manufacturing method of the present invention, it is possible to reduce material expenses and working expenses such as an expense of heat treatment.

### Embodiment 5

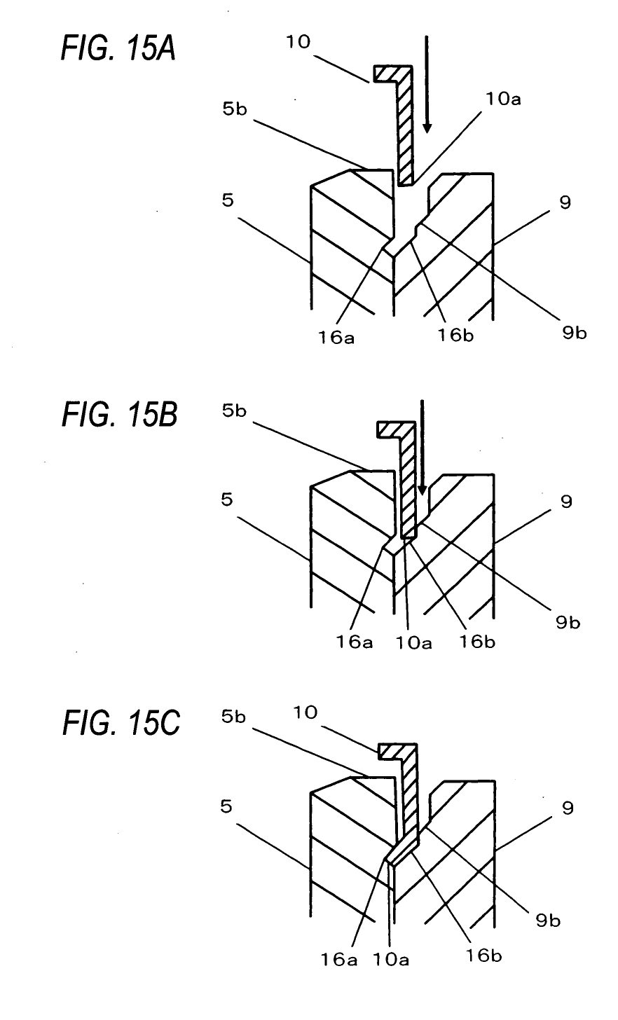

FIGS. 15A to 15C are enlarged views showing stepwise a primary portion of the fixing mechanism of the bearing sleeve of Embodiment 5 of the present invention. In this embodiment, an outer diameter of the inserting portion of the fixing ring 10 is set a little smaller than an inner diameter of the portion of the housing 5 into which the fixing ring 10 is inserted. FIGS. 15A to 15C show a progress from the insertion to the fixation. Concerning the fixing ring 10, the same fixing ring 10 as that shown in FIGS. 10A and 10B are used.

First, FIG. 15A is an enlarged view of a primary portion showing a stage of starting inserting the fixing ring 10 into the housing 5. On the inner face of the housing 5, the first recess portion 16a is previously formed. On the outer circumferential face 9b of the bearing sleeve 9, the second recess portion 16b is previously formed. Since the maximum outer diameter of the inserting portion of the fixing ring 10 is set to be a little smaller than the inner diameter of the portion of the housing 5 into which the fixing ring 10 is inserted, when the end portion 10a of the fixing ring 10 on the inserting side is inserted in the arrowed direction along the inside of the opening side end portion 5b of the housing 5, the insertion is started without giving an elastic deformation to the fixing ring 10.

FIG. 15B is an enlarged view of a primary portion showing a middle stage of inserting the fixing ring 10 into the housing 5. In this embodiment, the end portion 10a of the fixing ring 10 on the insertion side is formed into a straight shape. Since the outer diameter of the inserting portion of the fixing ring 10 is set to be a little smaller than the inner diameter of the portion of the housing 5 into which the fixing ring 10 is inserted, the end portion 10a smoothly proceeds into the housing 5 along the inner circumferential face without being given stress from the housing 5. FIG. 15B shows a state in which the end portion 10a of the fixing ring 10 comes into contact with the outer circumferential face 9b of the bearing sleeve 9.

When the fixing ring 10 is further pushed in the inserting direction at this stage, the end portion 10a of the fixing ring 10 is pushed outside by the contact with the outer circumferential face 9b of the bearing sleeve 9. Therefore, a deformation by pushing is started in such a manner that an outer diameter of the inserting portion of the end portion 10a of the fixing ring 10 is expanded to be larger than the outer diameter of the inserting portion before insertion.

In this case, a gap formed between the bearing sleeve 9 and the housing 5, into which the fixing ring 10 is inserted, is formed out of the straight inner face of the housing 5 and the outer circumferential face 9b of the bearing sleeve 9, the diameter of which is gradually expanded in the inserting direction (in the direction from the top to the bottom). Since this gap is formed so that the diameter can be gradually decreased in the inserting direction of the fixing ring 10, when the fixing ring 10 is inserted, the fixing ring 10 is pushed outside by the contact with the outer circumferential face of the bearing sleeve 9. Accordingly, a forward end portion 10a of the fixing ring 10 in the inserting direction easily engages with the housing 5. Therefore, according to this structure, an engagement can be easily accomplished in the direction opposite to the direction of inserting the fixing ring 10. Therefore, manufacturing can be easily executed.

FIG. 15C is an enlarged view of a primary portion showing a stage in which the fixing ring 10 completes fixing. In this structure, the fixing ring 10 is engaged with the recess portion 16, which is previously formed on the inner face of the housing 5, so as to fix the bearing sleeve 9. Therefore, the fixing ring 10 is engaged with the recess portion 16, which is formed on the inner face of the housing 5, and directly joined to the recess portion 16. At the same time, the fixing ring 10 is also engaged with and strongly joined to the second recess portion 16b formed on the outer circumferential face 9b of the bearing sleeve 9. Accordingly, the fixing ring 10 is engaged with and directly joined to the first recess portion 16a formed on the inner face of the housing 5. At the same time, the fixing ring 10 can fix the bearing sleeve 9.

That is, the fixing ring 10 is strongly joined to the housing 5 under the condition that the fixing ring 10 is engaged in the direction in which the fixing ring 10 comes out from the housing 5. At the same time, the fixing ring 10 also fixes the bearing sleeve 9. Accordingly, even when the fixing ring 10 is not press-fitted into the housing 5, the bearing sleeve 9 can be more strongly fixed. When the fixing ring 10 is inserted into and engaged with the housing 5, the fixing ring 10 may be only pushed.

At the same time, the fixing ring 10 is also engaged with and strongly joined to the second recess portion 16b formed on the outer circumferential face 9b of the bearing sleeve 9. Therefore, it is possible to prevent the bearing sleeve 9 from rotating together with the shaft 3c. Further, an increase in the vibration and a seize of the bearing sleeve 9 can be effectively prevented.

### Embodiment 6

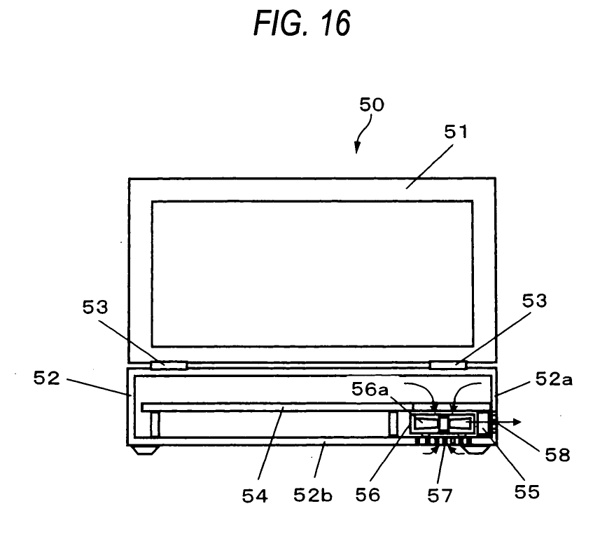

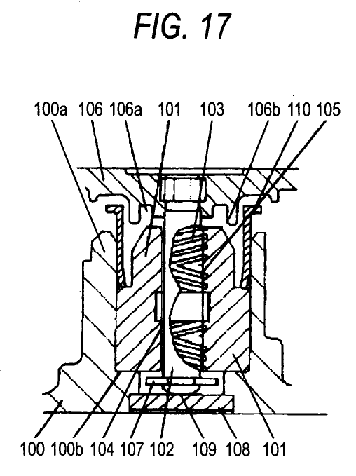

FIG. 16 is a view showing an inside of a casing of an electronic device on which a fan device of the present invention is mounted. This electronic device 50 is a lap-top type personal computer composed in such a manner that an opening and closing type liquid crystal display 51 is pivotally supported by a hinge mechanism 53 arranged at an end portion of a main body device 52 having an operating portion.

This view shows the following state. On the lower side of a circuit board 54 arranged inside the casing of the main body device 52 of the electronic device 50, a heat generating electronic component (not shown) to be cooled is mounted. A heat sink 55 having a plurality of heat radiating fins thermally connected to the heat generating electronic component is arranged on a casing side 52a of the main body device 52.

A fan device 56 is composed in the substantially same manner as that explained in Embodiment 1. The fan device 56 is mounted in a portion below the circuit board 54 so that the fan device 56 can be adjacent to the heat sink 55. A fan cover is set on the lower side and a fan casing is set on the upper side.

Air flows from the lower side of the main body device 52 and passes through a plurality of ventilation holes 57, which are provided on the bottom face 52b side of the main body device 52, and is sucked from a suction port of the fan cover. At the same time, air in the main body device 52 is sucked from a suction port of the fan casing. Inside the fan device 56, a direction of the air flow is changed in the centrifugal direction of the fan 56a. Therefore, while most of the air is colliding with the inner walls of the fan casing and the fan cover, the blast of air is sent along the inner walls in the same direction as the rotary direction of the fan 56a and discharged from the exhaust port. Further, the blast of air passes through among the heat radiating fins of the heat sink 55 while exchanging heat. Finally, the blast of air passes through a ventilation hole 58, which is provided on the casing side 52a of the main body device 52, and discharges outside.

In this case, the fan device 56 mounted on the electronic device 50 is a fan device including a bearing sleeve fixing mechanism of the present invention. Therefore, the electronic device 50 can be downsized and reduced in weight in addition to an enhancement of the reliability. Accordingly, the manufacturing cost can be reduced.

In this connection, Embodiments 1 to 6 explained before include a dynamic pressure type fluid bearing having dynamic pressure generating grooves 9a inside the bearing sleeve 9. However, it should be noted that bearings of the other type may be used. For example, it is possible to use a sliding bearing in which an oil impregnation type porous metal is used so as reduce the friction resistance. That is, the type of the bearing sleeve is not necessarily limited to the specific embodiment.

Many modifications and variations of the present invention are possible in the light of the above techniques. It is therefore to be understood that within the scope of the invention, the invention may be practiced otherwise than as specifically described.

This application is based upon and claims the benefit of priority of Japanese Patent Application No. 2005-247124 filed on May 8, 1929, the content of which is incorporated herein by references in its entirety.

What is claimed is:

1. A bearing sleeve fixing mechanism adapted for a fan device, comprising:
a shaft for pivotally supporting a fan;
a bearing sleeve, into which one end portion of the shaft is inserted, for pivotally supporting the shaft;
a housing having a cylindrical portion to accommodate the bearing sleeve and also having a receiving mount, which comes into contact with one end face of the bearing sleeve, in the cylindrical portion; and
a fixing ring coming into contact with another end face of the bearing sleeve;
wherein a recess portion is formed on an inner circumferential face of the cylindrical portion of the housing, a protruding and recessing portion is formed on one end portion side of the fixing ring, and a recessing portion of the housing and a protruding portion of the fixing ring are engaged with each other.

2. A bearing sleeve fixing mechanism according to claim 1, wherein an inner diameter of a central cylinder of the bearing sleeve is substantially the same as an outer diameter of the shaft, a diameter of the outer circumference of the bearing sleeve is substantially the same as an inner diameter of the housing, and an outer circumference of one end portion of the fixing ring is connected to an outer circumference of the bearing sleeve on an inclined face and smaller than a diameter of the outer circumference of the bearing sleeve.

3. A bearing sleeve fixing mechanism according to claim 1, wherein a protruding and recessing side of the fixing ring is inclined inside.

4. A bearing sleeve fixing mechanism according to claim 1, wherein a plurality of slits are formed on one end side of the fixing ring.

5. A bearing sleeve fixing mechanism adapted for a fan device, comprising:
a shaft;
a bearing sleeve, into which one end portion of the shaft is inserted, for pivotally supporting the shaft;
a housing for accommodating the bearing sleeve; and
a fixing ring inserted into the housing so that the bearing sleeve can be interposed between the fixing ring and a receiving mount provided in the housing,
wherein the fixing ring fixes the bearing sleeve by giving a plastic deformation to the housing so that a recess portion can be formed in the housing.

6. A bearing sleeve fixing mechanism according to claim 5, wherein a gap between the bearing sleeve and the housing, into which the fixing ring is inserted, is formed in such a manner that the gap is gradually reduced in a direction of inserting the fixing ring.

7. A bearing sleeve fixing mechanism according to claim 5, wherein an end portion of the fixing ring, by which a plastic deformation is given to the housing so as to form a recess portion, is protruded onto the outer circumferential side.

8. A bearing sleeve fixing mechanism according to claim 5, wherein the fixing ring fixes the bearing sleeve to the housing by giving a plastic deformation to both the bearing sleeve and the housing so that a recess portion can be formed in each of the bearing sleeve and the housing.

9. A bearing sleeve fixing mechanism according to claim 5, wherein an end portion of the fixing ring, by which a plastic deformation is given to the housing so as to form a recess portion, is formed into a protruding and recessing shape.

10. A bearing sleeve fixing mechanism according to claim 5, wherein the bearing sleeve is inserted into the housing while a gap of not more than 0.1 mm is being formed between the housing and the bearing sleeve.

11. A bearing sleeve fixing mechanism according to claim 5, wherein the bearing sleeve is press-fitted into the housing by an interference of not more than 5 μm.

12. A fan device comprising a bearing sleeve fixing mechanism according to claim 1.

13. A method of manufacturing a bearing sleeve fixing mechanism adapted for a fan device described in claim 1 comprising:
a first step for accommodating the bearing sleeve in the housing;
a second step for inserting the fixing ring into the housing; and
a third step for fixing the bearing sleeve when the fixing ring is engaged with a recess portion formed on an inner face of the housing.

14. A method of manufacturing a bearing sleeve fixing mechanism adapted for a fan device described in claim 5, comprising:
a first step for accommodating the bearing sleeve in the housing;
a second step for inserting the fixing ring into the housing; and
a third step for fixing the bearing sleeve when the fixing ring gives a plastic deformation to the housing so as to form a recess portion.
